(19) United States
(12) Patent Application Publication
(10) Pub. No.: US 2025/0046831 A1
(43) Pub. Date: Feb. 6, 2025

(54) MULTI-LAYER SEAL FOR SEVERE FUEL CELL APPLICATIONS

(71) Applicant: GM GLOBAL TECHNOLOGY OPERATIONS LLC, Detroit, MI (US)

(72) Inventors: Siguang Xu, Rochester Hills, MI (US); Joseph P. Truchan, Oxford, MI (US); James A. Leistra, Penfield, NY (US)

(73) Assignee: GM GLOBAL TECHNOLOGY OPERATIONS LLC, Detroit, MI (US)

(21) Appl. No.: 18/364,510

(22) Filed: Aug. 3, 2023

(51) Int. Cl. H01M 8/0276; H01M 8/0247; H01M 8/0267; H01M 8/028

(52) U.S. Cl. CPC H01M 8/0276; H01M 8/0247; H01M 8/0267; H01M 8/028; H01M 2250/20

(57) ABSTRACT

A fuel cell stack includes end plate units each having a metal plate, a dielectric plate, and a perimeter groove defined by the dielectric plate and an edge of the metal plate. The stack also includes a gas inlet and a coolant inlet configured to receive a reactant gas and coolant into the fuel cell stack, respectively, fuel cells having a pair of bipolar plates, and a multi-layer seal disposed within the fuel cell stack on the end plate units or the bipolar plates. The multi-layer seal includes a first layer constructed of a first material that is substantially impermeable to the reactant gas, and a second layer constructed of a second material that is more resistant to corrosion than is the first material.

### INTRODUCTION

The present disclosure relates to electrochemical fuel cell systems operable for converting a gaseous reactant such as hydrogen into electricity. More specifically, aspects of the disclosure relate to the internal sealing of the fuel cell system.

Advanced hybrid-electric and full-electric vehicles may employ a fuel cell system to produce an electrical current suitable for operating one or more electric traction motors. As appreciated in the art, a hydrogen (H2) fuel cell is an electrochemical device composed of a negative electrode/anode that receives a supply of gaseous H2, a positive electrode/cathode that receives ambient air as an oxidizing agent, and an electrolyte barrier interposed between the anode and cathode. An induced electrochemical reaction oxidizes H2 molecules at the anode side. The H2 gas is catalytically split to generate free electrons and protons. The free protons pass through the electrolyte barrier to the cathode side of the fuel cell and react with oxygen (O2) molecules. Water vapor and heat form inert by-products of this reaction. The free electrons from the anode are then directed to a connected load, e.g., the above-noted electric traction motor(s) and accessories.

Fuel cell stacks for automotive and other high current applications often utilize a solid polymer electrolyte membrane (PEM). The PEM provides ion transport between the aforementioned anode and cathode. The combination of the anode's catalytic layer, the cathode's catalytic layer, and an electrolyte membrane define a membrane electrode assembly (MEA). The MEA is disposed between gas diffusion layers (GDLs). The GDLs in turn are disposed between bipolar plates (BPPs) to form a fuel cell. Multiple fuel cells are assembled into a fuel cell stack to yield the requisite current and voltage for powering a given application. The BPPs collectively define circuitous flow channels for distributing H2 and O2 reactant gasses through the stack. Elastomeric seals or other types seals, e.g., metal bead seals, are provided around the edges of the MEA, surfaces of the BPPs, and end plate units of the stack to ensure effective separation of the reactant and coolant flows while also preventing leakage and intermixing of the various gasses.

### SUMMARY

Disclosed herein is a multi-layer seal for use in a fuel cell stack of the type described above. While the solutions detailed herein may be of particular benefit when applied to a fuel cell system (FCS) having a relatively small size and complicated geometry, and/or with multiple design requirements where press-in-place (PIP) seals and other types of seals do not fit properly, the present teachings may be extended to a larger or less complex FCS without limitation.

The multi-layer seal as contemplated herein includes multiple sealing layers, and thus is suitable for use with an FCS in severe application conditions, for instance acidic or corrosive operating environments. The multi-layer seal in some implementations could be used to seal a non-repeating hardware (NRHW) component, e.g., an end unit of the fuel cell stack, or to seal repeating hardware such as a bipolar plate (BPP). Although adjacent sealing layers could be constructed of the same material, different materials are used in other embodiments to provide additional benefits as described below. Attendant processes for applying the various sealing layers could likewise be the same or different, e.g., one layer may be applied by a formed-in-place gasket (FIPG) process while other layers could be applied using a room temperature vulcanizing (RTV) sealant process or a dispensing process. Each sealing layer could be applied using screen printing or dispensing processes, e.g., for the above-noted BPP seal, among other possible implementations.

Between sealing layers, the constructed layer-to-layer interfaces could be of strong or weak bond, or a gap may be formed between layers to avoid interference between adjacent layers. The geometry, shape, and/or thickness of each layer could vary depending on the application, with various possible constructions of the multi-layer seal disclosed in detail below.

In particular, a fuel cell stack is disclosed herein that includes a pair of end plate units. Each end plate unit has a metal plate, a dielectric plate, and a perimeter groove defined by the dielectric plate and an edge of the metal plate. The fuel cell stack also includes a gas inlet and a coolant inlet configured to receive a reactant gas and a coolant into the fuel cell stack, respectively, a plurality of fuel cells each having a pair of bipolar plates, and a multi-layer seal disposed within the fuel cell stack on the end plate units or the bipolar plates. The multi-layer seal includes first and second layers. The first layer in this embodiment is constructed of a first material that is effectively impermeable to the reactant gas and the coolant. The second layer in turn is constructed of a second material that is more resistant to corrosion than the first material.

The multi-layer seal is disposed between the metal plate and the dielectric plate of each of the end plate units. In one or more implementations, a bonding strength to the dielectric plate and a maximum tensile elongation of the second layer is higher than a bonding strength to the dielectric plate and a maximum tensile elongation of the first material.

The multi-layer seal may include an optional third layer that is disposed between the first layer and the third layer. The third layer could be constructed of a third material that is different than the first and second materials. The third material may include air, such that the third layer includes an air gap that is defined between the first layer and the second layer in this particular non-repeating hardware embodiment. The third material in accordance with aspects of the disclosure may have a low bonding strength with the first material or the second material, or both. The low bonding strength as contemplated herein is sufficient for reducing chemistry and bonding interference between the first layer and the second layer.

The bipolar plates may include a bead joint in one or more embodiments. In such a construction, the multi-layer seal may include a thin layer seal disposed on a surface of the bead joint.

The first material of the multi-layer seal may optionally include a foam fluorinated carbon-based synthetic rubber (FKM). The second layer could be applied to the surface of the bead joint as a solid FKM.

A fuel cell system (FCS) is also disclosed herein. An example of the FCS includes a reactant supply tank containing a reactant gas, a fuel cell stack in fluid communication with the reactant supply tank and configured to receive coolant and the reactant gas, and a load. The load is configured to be driven by an electrical current from the fuel cell stack. The fuel cell stack includes a pair of end plate units each having a metal plate, a dielectric plate, and a perimeter groove defined by the dielectric plate the metal plate, a coolant inlet and a gas inlet configured to respectively receive the coolant and reactant gas into the fuel cell stack. The stack also includes a plurality of fuel cells. each respective fuel cell of which includes a bipolar plate. A multi-layer seal is disposed within the fuel cell stack, includes a first layer constructed of a first material that is effectively impermeable to the reactant gas and coolant, and a second layer constructed of a second material that is more resistant to corrosion than the first material.

A method for sealing a fuel cell stack having a plurality of fuel cells disposed between end plate units includes applying a first material to an end plate unit or a bipolar plate of the fuel cells as a first layer. The first layer has low permeation to a reactant gas and the particular coolant used in the fuel cell stack, e.g., water. The method also includes applying a second material to the end plate unit or the bipolar plate as a second layer, thereby forming a multi-layer seal, with the second material being more resistant to corrosion than the first material. The method further includes curing the first layer and the second layer to thereby form the multi-layer seal.

In one or more possible implementations, the method includes applying a third material as a third layer between the first and second layers. The third material is different than the first and second materials in this approach, and has a low bonding strength therewith. The low bonding strength is sufficient for reducing chemistry and bonding interference between the first and second layers.

Applying the first material could optionally include using a form-in-place gasket process, while applying the second material could include using a manual dispensing process.

The above-summarized and other features and advantages of the present teachings are readily apparent from the following detailed description of some of the best modes and other embodiments for carrying out the present teachings, as defined in the appended claims when taken in connection with the accompanying drawings.

### BRIEF DESCRIPTION OF THE DRAWINGS

FIG. 1 illustrates a representative motor vehicle equipped with a powertrain system having a fuel cell system (FCS), with the FCS constructed using a multi-layer sealing strategy in accordance with the present disclosure.

FIG. 2 illustrates a representative fuel cell stack having a multi-layer seal according to the present disclosure.

FIGS. 3A and 3B are a respective plan view and partial perspective view of non-repeating hardware (NRHW) section of the fuel cell stack shown in FIGS. 1 and 2.

FIG. 3C is a plan view illustration of an exemplary bipolar plate (BPP) of the fuel cell stack shown in FIGS. 1 and 2.

FIGS. 4A, 4B, and 4C are partial cross-sectional side view illustrations of a portion of the NRHW section of the representative FCS shown in FIG. 1, with the multi-layer seal disposed in a perimeter joint between a steel plate and a representative dielectric plate of the NRHW section.

FIG. 5 is a cross-sectional side view of a representative metal bead usable as part of a bipolar plate (BPP) of the exemplary fuel cell stack shown in FIGS. 1 and 2.

FIGS. 6A and 6B are schematic illustrations of a multi-layer thin seal material applied on top of a metal bead to form a BPP seal on the BPP of FIG. 3C within the fuel cell stack of FIGS. 1 and 2.

FIGS. 7A and 7B illustrate exemplary pressure distributions on a bead seal of different constructions.

FIG. 8 illustrates a two-layer elastomer seal in accordance with an aspect of the disclosure.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

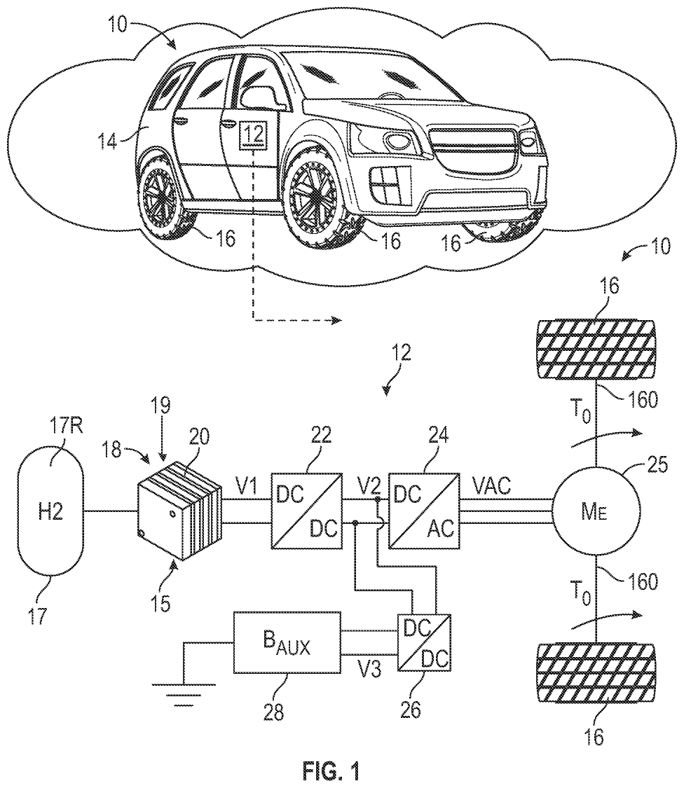

Referring to the drawings, wherein like reference numerals correspond to similar components throughout the several Figures, a motor vehicle 10 equipped with a fuel cell system (FCS) 12 is shown in FIG. 1. The motor vehicle 10 includes a vehicle body 14 connected to a set of road wheels 16. As shown, the motor vehicle 10 is configured as a passenger vehicle, e.g., a sport utility vehicle, sedan, truck, motorcycle, etc. However, the FCS 12 could be incorporated into a wide range of vehicles such as boats, aircraft, rail vehicles, farm equipment, etc., non-vehicular mobile platforms, or stationary systems such as power plants, hoists, and the like. The motor vehicle 10 of FIG. 1 is used hereinafter as an exemplary host system for the FCS 12 without limiting the present teachings to such a use.

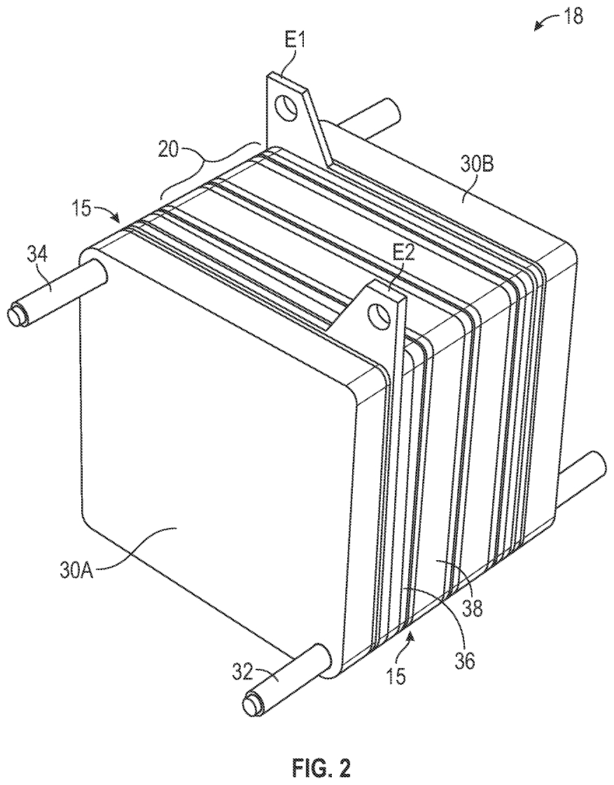

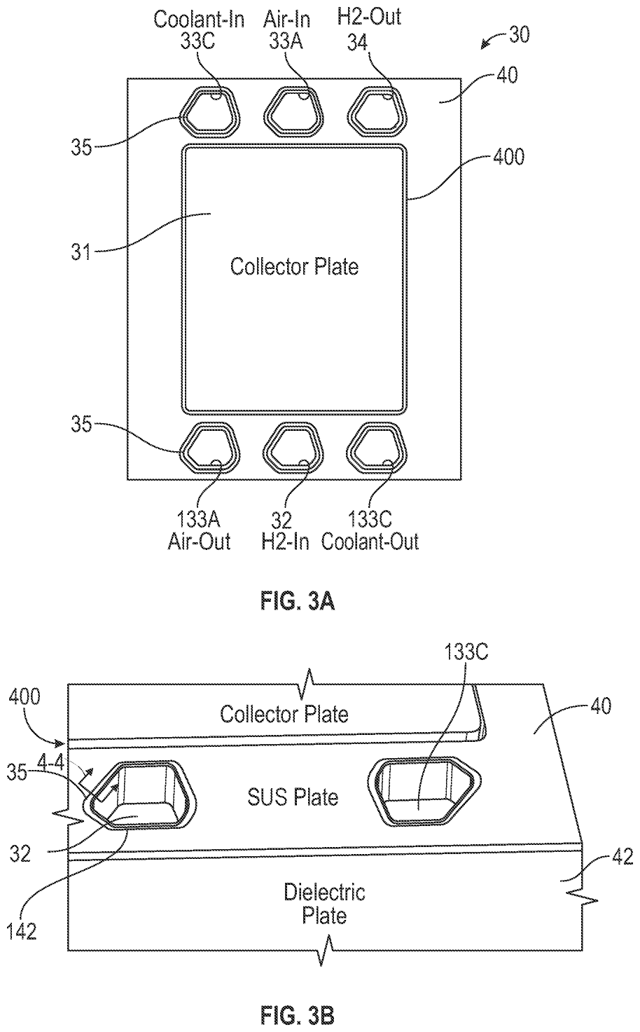

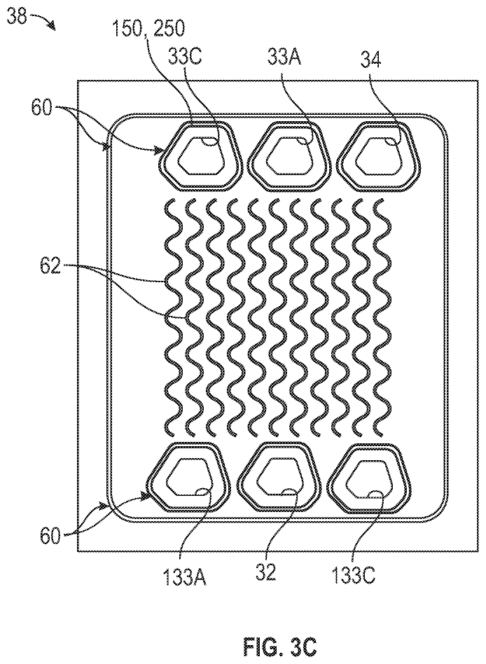

The FCS 12 of FIG. 1 includes a fuel cell stack 18 having an application-suitable number of fuel cells 20 arranged therewithin, with an exemplary configuration of the fuel cell stack 18 depicted in FIG. 2. A multi-layer seal 15 is disposed within the fuel cell stack 18 in one or more locations, possibly including on or along interfacing surfaces of end plate units 30A and 30B or other non-repeating hardware (NRHW) section 30 as shown in FIGS. 2-4C, between adjacent beads 60-1 of bipolar plates 38 (FIGS. 2 and 3C) as illustrated in FIGS. 6A and 6B, and/or on other internal or external surfaces 80 of the fuel cell stack 18 as shown in FIG. 8, e.g., as a press-in-place (PIP) seal or elastomer seal. Use of the multi-layer seal 15 as set forth thus increases sealing integrity and overall durability of the fuel cell stack 18, and thereby renders the fuel cell stack 18 more suitable for use in relatively severe operating environments.

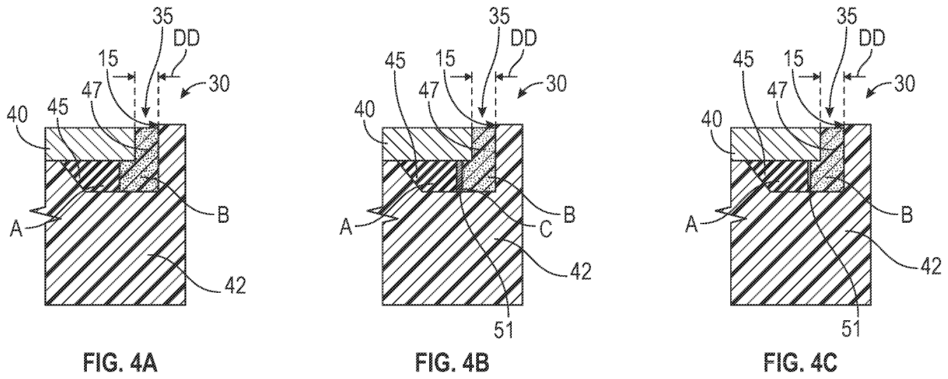

The multi-layer seal 15 for its part is applied in accordance with various processes as specified herein, thus facilitating manufacturing. As contemplated herein, each respective layer of the multi-layer seal 15 serves a specific sealing function in order to meet multiple seal requirements. For instance, as shown in the non-repeating hardware embodiment of FIGS. 3A and 3B as shown in closer detail in FIGS. 4A, 4B, and 4C, taken along a cut line 4-4 of FIG. 3B, a first layer 45 could be constructed of a first material (A) having a high-density to meet hydrogen and coolant permeation requirements, i.e., low permeation/effectively impermeable to H2 and coolant permeation as specified herein, while a second layer 47 (B) could be used for high acid and coolant corrosion resistance, e.g., for sealing an end plate of the fuel cell stack. As used herein, “low permeation” and “effectively impermeable” refer to a gas diffusion rate through a fluoropolymer material such as SIFEL® or VITON® that is less than a diffusion rate for a suitable silicon such as DOWSIL™. The substantially impermeable material may have a gas permeation (diffusivity) coefficient of less than about 0.5-1.5×10⁻¹⁰ (m²/s) for H2, which could be less than about 25% of the permeation coefficient of the second layer 47.

Likewise, material A could be used to form a primary seal while material B acts as a protective layer for material A. Different materials may be used within the scope of the disclosure to construct respective first and second layers 45 and 47 of materials A or B, e.g., polyolefin elastomer, silicone rubber, ethylene propylene diene monomer (EPDM), nitrile rubber (NBR), hydrogenated nitrile rubber (HNBR), vinyl methyl silicone, phenyl methyl, various fluoro-elastomers/rubbers (formable or non-formable), polytetrafluoroethylene (PTFE), etc. These sealants may be cured at room temperature or at an elevated temperature, e.g., within an oven.

Apart from forming perimeter seals in the end plate or other NRHW section 30 of FIGS. 4A-C, the multi-layer seal 15 described below could be used with bead seals 60-1 (see FIGS. 6A and 6B) to increase seal thickness and reduce seal sensitivity to contamination. Such a use could help provide a larger seal load range and optimal pressure distribution profile as depicted in FIG. 7B. In some embodiments, less expensive materials could be used for internal layers or other protected or non-exposed areas of the seal. The use of the multi-layer seal may also reduce seal permeation and increase set load with harder and denser internal layers. Such features and benefits will be described in more detail below with reference to FIGS. 4A-8.

Referring once again to FIG. 1, the motor vehicle 10 is just one possible host system for the FCS 12 and its resident fuel cell stack 18. Other types of vehicles and mobile systems could use a similarly constructed FCS 12, e.g., boats, rail vehicles, aircraft, farm equipment, mobile platforms, and the like. Stationary systems including for instance powerplants, hoists, standby electric power supplies, etc., could likewise employ the FCS 12 and fuel cell stack 18. The motor vehicle 10 is therefore illustrative and non-limiting of a representative type of host system that could benefit from the sealing techniques described herein.

The FCS 12 of FIG. 1 uses the fuel cell stack 18 to generate onboard electricity. As appreciated in the art, air and hydrogen (H2) or another suitable reactant gas 17R are fed from a reactant supply tank 17 that is in fluid communication with the fuel cell stack 18, e.g., via a series of valves, pressure regulators, and fittings (not shown). A suitable coolant 19 is similarly circulated through the fuel cell stack 18 to regulate temperature of the fuel cell stack 18. The fuel cell stack 18 for its part is constructed from an application-suitable number of fuel cells 20. The fuel cell stack 18 ultimately produces an electrical current, with water vapor and heat being byproducts of its operation.

An electrified powertrain system 11 using the fuel cell stack 18 may include a direct current-to-direct current (DC/DC) converter 22 to convert a DC output voltage (V1) from the fuel cell stack 18 into an application-suitable voltage (V2). This action may be performed via a boost operation facilitated by high-speed switching of semiconductor power switches and transformers (not shown) residing within the DC/DC converter 22, as appreciated in the art. The electrified powertrain system 11 may include an alternating current (AC) traction motor (ME) 25 as shown as part of a driven load, in this instance an electric traction motor coupled to one or more of the road wheels 16 via a shaft 160.

A direct current-to-alternating current (DC/AC) inverter 24 is disposed between the DC-DC converter 22 and the traction motor 25 in this configuration. Internal switching operation of the inverter 24 ultimately converts the DC input voltage (V2) into an alternating current voltage (VAC) suitable for energizing phase windings of the traction motor 25, thus causing machine rotation and transmission of motor output torque (To) to the road wheels 16. Other possible components of the electrified powertrain system 11 may include an auxiliary power module 26, i.e., another DC/DC converter operable for decreasing the voltage level (V2) from the DC bus to an auxiliary voltage level (V3), which is nominally about 12-15V. A low-voltage auxiliary battery (BAUX) 28 is thus fed with the auxiliary voltage (V3) to power low-voltage functions aboard the motor vehicle 10.

Referring briefly to FIG. 2, the fuel cell stack 18 whose sealing is accomplished herein using the multi-layer seal 15 is shown in simplified form. The NRHW section 30 of FIGS. 3A-3B and 4A-4C, sealed via the multi-layer seal 15 as set forth below, includes the pair of end plate units 30A and 30B between which is arranged a plurality of the fuel cells 20 and electrodes E1 and E2. Each fuel cell 20 includes a pair of the bipolar plates (BPPs) 38, with a membrane electrode assembly (MEA) 36 disposed therebetween. One or more gas inlets 32 are configured to receive a flow of a suitable reactant gas such a hydrogen (H2) into the fuel cell stack 18. One or more gas outlets 34 likewise allow venting of water vapor and heat to the surrounding ambient environment. Other ports for supplying coolant and air are omitted for simplicity, but are shown in the non-limiting embodiment of FIGS. 3A and 3B. Positive and negative electrodes with a suitable dielectric coating are arranged at opposing ends of the fuel cell stack 18 as shown. The multi-layer seal 15 could be used within the fuel cell stack 18 in various locations to optimize the sealing integrity of the fuel cell stack 18 in oxidizing, acidic, or other severe operating conditions, as will now be explained with reference to the remaining Figures.

Referring to FIG. 3A and 3B, the NRHW section 30 is shown in plan view and partial perspective view, respectively, to include a collector plate 31 disposed within a coated metal plate 40 (“SUS Plate”), which in turn is connected to a dielectric plate 42 as shown in FIG. 3B. The current collector 31 is surrounded by a perimeter groove 400, which may be filled by a press-in-place (PIP) seal as appreciated in the art. In the representative configuration of FIG. 3A, the metal plate 40 defines a plurality of fluid ports or passages, including the gas inlet 32 and the gas outlet 34 shown in the different configuration of FIG. 2. Also illustrated in FIG. 3A is a coolant inlet ports 33C, an air inlet port 33A, an air outlet port 133A, and a coolant outlet port 133C. The particular number, location, and shape of the various fluid ports or passages may vary with the construction of the NRHW section 30, and therefore the particular configuration of 3A is illustrative of the present teachings and non-limiting.

In accordance with the disclosure, the NRHW section 30 thus presents various interfacing surfaces that would benefit from the multi-layer sealing approach described herein. For instance, the gas inlet 32 and coolant inlet port 133C visible in FIG. 3B are surrounded by a perimeter groove 35, which in turn is defined by the dielectric plate 42 and an edge of the metal plate 40. Thus, a flange portion 142 of the dielectric plate 42 protrudes through the gas inlet 32, the coolant inlet port 133C, and other ports of FIG. 3A as shown, with the perimeter groove 35 surrounding the flange portion 142. Other locations for the disclosed sealing approach are described below with reference to FIGS. 3C and 5A-8.

Referring now to FIGS. 4A, 4B, and 4C, the above-noted multi-layer seal 15 may be used within the NRHW section 30 of FIGS. 3A and 3B to provide attendant benefits in a myriad of ways. As shown, for example, the NRHW section 30 includes the end plate units 30A and 30B of FIG. 2, a partial cross-sectional view of which is depicted. As appreciated in the art, such structure is representative of interfacing portions of the fuel cell stack 18 where disparate materials are positioned immediately adjacent to each other. In this instance, the metal plate 40, for instance 304 or 316 stainless steel (about 1 mm to about 10 mm thick), may be compressed against the dielectric plate 42, e.g., polyphenylene sulfide (PPS) reinforced with glass fibers or another electrically-insulating material. As the respective metal and dielectric plates 40 and 42 are brought into close proximity of each other by such compression, a bead of sealing material that is initially disposed between the metal plate 40 and the dielectric plate 42 is forced away or squeezed into the perimeter groove 35 defined by the dielectric plate 42 and an edge and surfaces of the metal plate 40, with the perimeter groove having a width dimension (DD) of about 1 mm to about 5 mm or more. The perimeter groove 35 is sealed via the multi-layer seal 15 as set forth below.

The materials in this portion of the fuel cell stack 18 are disparate in composition (i.e., metal vs. dielectric) as well as in surface roughness, with the dielectric plate 42 being nominally “rough” and the metal plate 40 being nominally “smooth” in a relative context. Such materials have vastly different coefficients of thermal expansion, thus rendering locations such as the representative NRHW section 30 difficult to properly seal. In such a sealing application or in similar applications, therefore, the use of the multi-layer seal 15 of the present disclosure would provide various attendant benefits, and could be constructed as a formed-in-place gasket (FIPG), or via dispensing, room temperature vulcanizing (RTV), or injection molding processes for the various locations of the multi-layer seal 15.

Referring to FIG. 4A, for instance, after the above-noted compression of the metal plate 40 and the dielectric plate 42, a thin layer of sealing material remains therebetween, with the majority expelled into the perimeter groove 35. In this instance, one could employ multiple sealing materials as the constituent layers of the multi-layer seal 15. The multi-layer seal 15 would then be disposed between the metal plate 40 and the dielectric plate 42 of each end plate unit 30A and 30B.

Here, nominal first and second materials A and B could be used to form respective first and second layers 45 and 47. As noted above, the materials A and B could have different material compositions and/or properties in one or more implementations. For example, the first material A could be substantially impermeable to H2 or another reactant gas, and coolant, as used in the fuel cell stack 18, with “low permeation” and “effectively impermeable” as used herein meeting required H2 and coolant permeation specifications for the selected embodiments. For example, the first material A could have high density to prevent H2 permeation when H2 is used as the reactant gas 17R of FIG. 1, or permeation for the corresponding coolant. The second material B for its part could be more resistant to corrosion than is the first material/material A so as to resist corrosion due to coolant and acids that might be present in the working environment of the FCS 12 of FIG. 1. In this manner, the multi-layer seal 15 would improve robustness and durability of the fuel cell stack 18 of FIG. 2 to relatively harsh or severe operating environments.

In this or other embodiments, the second material B used to form the second layer 47 could have a bonding strength and maximum allowable shear/compressive deformations or tensile elongation that is higher than those of the first layer 45 and its first material A, but possibly with higher H2 permeation. The synergy of materials A and B would therefore provide the desired sealing qualities at different locations on and within the fuel cell stack 18 of FIG. 2.

FIG. 4B depicts the multi-layer seal 15 with an additional third layer 51. denoted as material C. Material C, which may be different than the first material/material A of first layer 45 and the second material/material B of the second layer 47 in some embodiments, is disposed between the aforementioned first and second layers 45 and 47. In this optional three-layer approach, the third layer 51 is applied thinly between the first and second layers 45 and 47. Here, the third layer 51 constructed of a third material C has a low bonding strength with the first material A, or the second material B, or both A and B. Introducing the third layer 51 when forming an end unit seal as shown may reduce chemistry and bonding interference between the first and second materials A and B of the respective first and second layers 45 and 47. Therefore, a failure of the first layer 45 would not adversely affect the sealing performance of the second layer 47, and vice versa. In this exemplary embodiment, material A and material B could be the same material.

FIG. 4C for its part depicts essentially the same structure as FIG. 4B, with the third layer 51/third material C replaced with an air gap. Thus, the “material” of the third layer 51 in this instance is air, i.e., an air-filled gap or a void pocket situated between the first and second layers 45 and 47. Such an approach would achieve a similar effect as the third layer 51 of FIG. 4B. Potential difficulties in implementing the solution of FIG. 4C include maintaining separation of the respective first and second layers 45 and 47, thus likely necessitating the use of fixtures, tooling, or sacrificial elements therebetween.

Referring briefly to FIG. 3C, the fuel cell stack 18 of FIGS. 1 and 2 may also include one or more bead joints 60 disposed on the bipolar plate (BPP) 38 (see FIG. 2). As appreciated in the art, the BPP 38 is a repeating hardware element, as opposed to the NRHW section 30 shown in FIGS. 4A-C. The BPP 38 separates constituent fuel cells 20 of the fuel cell stack 18 shown in FIG. 2, and is serially connecting the fuel cells 20 to form the fuel cell stack 18. A BPP 38 may also provide various flow channels 62 for hydrogen (H2), oxygen (O2), and coolant 19 flow within the fuel cell stack 18, thus distributing the reactant gasses 17R of FIG. 1 across surfaces of the fuel cells 20.

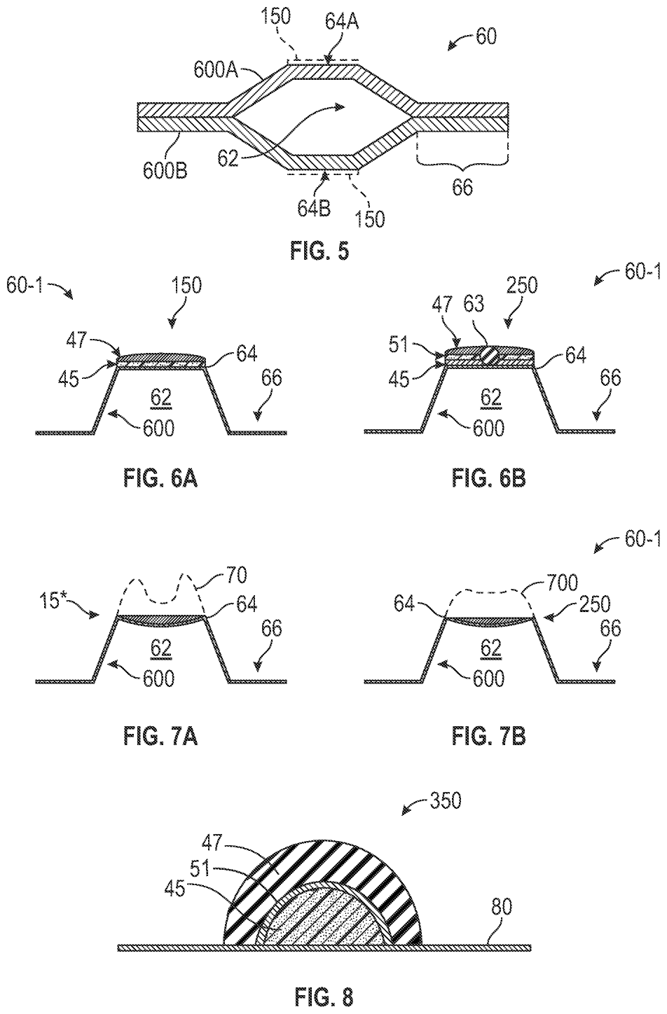

The BPP 38 may include the bead joints 60 formed from an application-suitable metal material, e.g., stainless steel, titanium, aluminum, or another metal or metals. As appreciated in the art, the bead joints 60 could be constructed from non-metal materials such as graphite, and therefore the bead joints 60 are not limited to metal constructions. To mitigate against undesirable leakage of fluids between adjacent BPP 38 or between the BPP and the metal plate 40 of FIGS. 3A and 3B, the bead joints 60 may be sealed via the multi-layers seals 150, 250, or 350 of FIGS. 5A and 5B as described below. Such bead joints 60 could be disposed along a peripheral edge of the BPP 38 and/or a periphery of the various ports 33C, 33A, 34, 133A, 32, and 133C.

As shown in FIGS. 5A and 5B, each bead joint 60 may be formed in one or more constructions by interfacing metal plates 600A and 600B to form the flow channels 62 therebetween. Flat ends 66 are joined (e.g., laser welding) or sealed (e.g., bonded) together to further define the flow channels 62. Surfaces 64A and 64B of the bead joint 60 could be sealed via a multi-layer seal 150 of the present disclosure. The multi-layer seal 150, as an embodiment of the multi-layer seal 15 of FIGS. 1-4C, could therefore be formed as a metal bead seal disposed on the surfaces 64A and/or 64B of the metal bead joint 60.

Referring now to FIGS. 6A and 6B, for example, such a bead seal is illustrated as a bead seal 60-1 of the bead joint 60 of FIG. 5. The bead seal 60-1 has a multi-layer seal 150 located on the surface 64 (i.e., surface 64A and/or 64B) as a bead seal. When properly formed, the multi-layer seal 150 prevents leakage of the reactant gas 17R of FIG. 1. Structurally, bead seals may take the form of a protrusion along surfaces, e.g., of the BPP 38 of FIG. 2. When the fuel cell stack 18 is ultimately assembled, multi-layer seals 150 (bead seals) of adjacent BPPs 38 are pressed together, which in turn compresses the multi-layer seals 150. As a result, H2 does not escape from the fuel cell stack 18. There are openings (not shown) on the flow channels 62 that allow reactants/coolant to enter the active area of cell (ex, 62 in FIG. 3C), as appreciated in the art.

The representative multi-layer seal 150 of FIGS. 6A and 6B includes the above-described first and second layers 45 and 47, with the implementation of FIG. 6B also including the optional third layer 51. As understood in the art, typical single-layer seals used at the indicated location are screen-printed to a desired thickness, e.g., about 30-40 microns. This limits allowable contaminant sizes, which are to be less than the seal thickness, with a representative contaminant 63 having a larger-than-single-layer seal thickness being shown in the multi-layer seal 250 of FIG. 6B.

It is recognized herein that a single-layer approach does not provide required sealing pressures at the center of the seal 150 when seal load is high and top surface of metal bead deforms. An uneven or “M-shaped” pressure distribution profile 70 of FIG. 7A illustrates this potential problem of a typical single-layer bead seal 15*, with the profile indicating that pressure is lowest in the middle of the single-layer bead seal 15 *. Sealing integrity or sealability is thus lower across this center region.

The multi-layer seals 150 and 250 of FIGS. 6A and 6B help address this issue. A thicker seal is applied along the center region of the surface 64 via multi-path/multi-layer screen printing, or via a combination of screen printing and dispensing. As understood in the art, screen printing involves the use of a fine mesh screen stretched over a frame and blocking off certain areas where printing is not desired. Dispensing for its part includes a controlled application of sealant in a continuous bead or line of sealant material along the surfaces to be sealed. The materials of respective first, second, and third layers 45, 47, and 51 may be the same or different materials to provide the desired sealing properties.

By way of illustration, the second layer 47 could be constructed of a foam fluorinated carbon-based synthetic rubber (FKM) to reduce pressure profile variation of the type shown by pressure trace 70 in FIG. 7A, as well as to reduce sensitivity to contaminants. In terms of cross bead pressure profile, for instance, the flatter or more even pressure distribution 700 of FIG. 7B, here achieved with an option three-layer version of the multi-layer seal 250 of FIG. 6B, illustrates the potential result of incorporating the multi-layer seal 150 or 250 of FIGS. 6A or 6B into the structure of the BPP 38 (see FIG. 2) for better sealability. The first layer 45 and third layer 51 could be a solid FKM to reduce H2 or coolant permeation as noted above. Other screen-printable/dispensable materials could be used for similar end results within the scope of the disclosure.

Referring now to FIG. 8, the fuel cell stack 18 of FIG. 1 may also include a multi-layer seal 350, or alternatively a “press-in-place” or PIP seal on the surface 80 of the fuel cell stack 18 of FIG. 2, with surface 80 possibly being anywhere on or within the fuel cell stack 18. Such a multi-layer seal 350 may be used between various components of the fuel cell stack 18, for instance the BPPs 38, the MEAs 36, and the end plate units 30A, 30B. Assembly of the fuel cell stack 18 results in application of force on such an elastomer material seal, which in turn compresses to form a leak resistant seal. However, typical approaches use a single layer seal for this purpose, which may be either too soft or too stiff for the application, and which could also have suboptimal gas permeation properties due to thick elastomer.

As shown in FIG. 8, the present approach solves this potential problem using the multi-layer seal 350 as a thin-layer seal. This representative embodiment uses the first layer 45 and the second layer 47, with the optional layer 51 also depicted therebetween. The use of two or more elastomer layers for respective materials A and B in this instance alleviates the above-noted issues. For example, the first layer 45/material A may be selected as a relatively hard and relatively inexpensive material to reduce cost and H2 permeation, and to increase seal stiffness. The second layer 47/material B acting in this same example could be softer and more corrosion resistant than material B. “More corrosion resistant” refers to the material B of the second layer 47 maintaining a higher adhesive strength to both the dielectric (e.g., PPS) and metal plates 40 of FIGS. 4A-C in the presence of coolant and acidic liquid/vapor relative to the first layer 45.

As before, materials A and B could be dispensed or injection molded, thus facilitating manufacturability of the fuel cell stack. Likewise, the combination of the first and second materials would provide a required load deflection curve, permeation rate, corrosion resistance, at an optimal cost. The optional third layer 51 when used could be added between the respective first and second layers 45 and 47 in yet another embodiment to provide the additional sealing benefits described above.

Associated methods for sealing the fuel cell stack 18 of FIG. 1 or another such stack having a plurality of the fuel cells 20 disposed between end plate units 30A, 30B (generally referred to as NRHW 30) may generally include applying the first material A to the NRHW section 30 as the first layer 45. As noted above, the first layer 45 is impermeable to H2 or another reactant gas 17R, or coolant 19 used in the fuel cell stack 18. For example, the H2 permeability of the first layer 45 may be less than about 2e-13mole·m/(m³·s·Pa) at 25° C. Coolant permeability, e.g., when the coolant 19 is water, may be less than about 2 g/m² per twenty-four hour period at 25° C. Other values may be used in other implementations.

The method also includes applying the second material B to the NRHW section 30 as the second layer 47. The second material B could be more resistant to corrosion than is the first material A, as described above. Such a method could then proceed by curing the first layer 45 and the second layer 47, e.g., in an oven (or in air) at a suitable curing temperature, to form the multi-layer seal 15.

Optionally, such a method could include applying or forming the third material C as the third layer 51 between the first layer 45 and the second layer 47 (FIG. 4C). The third material C, which may be different than the first material 45 and the second material 47, also has a low bonding strength therewith, with the low bonding strength as contemplated herein being sufficient for reducing chemistry and bonding interference between the first layer 45 and the second layer 47 as noted above. Applying the first material A could include using a form-in-place gasket (FIPG) process, while applying the second material or third material C could include using a manual dispensing process, among other possible approaches.

As set forth above, the present disclosure enables use of the multi-layer seal 15 and its embodiments 150, 250, and 350 of FIGS. 4A-8 in various locations within the fuel cell stack 18 of FIG. 1. For an NRHW section 30 or end unit 30A, 30B of FIGS. 4A-C, for instance, one could use the FIPG method to apply the first layer 45/material A, and then use manual dispensing aided, e.g., by a syringe, to apply the second layer 47/material B, followed by low-temperature curing.

For a bead seal formed as the multi-layer seals 150 or 250 of the types respectively illustrated in FIGS. 6A and 6B, one may use screen printing to apply the first layer 45/material A, and possibly the optional third layer 51/material C, followed by low-temperature precuring and drying. Then, screen printing could be used to apply the second layer 47/material B, again followed by low-temperature precuring/drying. These steps may be followed by final curing at a suitably higher temperature than that used for precuring of the earlier-applied layers.

The present solutions may also be extended to elastomeric seals/PIP seals as shown by the multi-layer seal 350 of FIG. 8, e.g., by dispensing the first layer 45/material A and precuring the same, followed by dispensing of the second layer 47/material B and its precuring as noted above. An optional layer 51/material C can be applied between material A and material B to further optimize seal characteristics and sealability. Final curing may then commence at higher temperatures. The benefits of improved resistance to gas permeation and corrosion are thereby realizable in multiple different locations and types of seals within the representative FCS 12 of FIG. 1.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A fuel cell stack, comprising:
a pair of end plate units each having a metal plate, a dielectric plate, and a perimeter groove defined by the dielectric plate and the metal plate;
a coolant inlet and a gas inlet configured to receive coolant and a reactant gas into the fuel cell stack, respectively;
a plurality of fuel cells, wherein each respective fuel cell of the plurality of fuel cells includes a pair of bipolar plates; and
a multi-layer seal disposed within the fuel cell stack on the end plate units or the bipolar plates, the multi-layer seal including:
a first layer constructed of a first material that is substantially impermeable to the reactant gas and the coolant; and
a second layer constructed of a second material that is more resistant to corrosion than is the first material.

2. The fuel cell stack of claim 1, wherein the multi-layer seal is disposed between the metal plate and the dielectric plate of each of the end plate units.

3. The fuel cell stack of claim 2, wherein a bonding strength and a maximum tensile elongation of the second layer to the dielectric plate is higher than a bonding strength and maximum tensile elongation of the first material to the dielectric plate.

4. The fuel cell stack of claim 1, wherein the multi-layer seal includes a third layer that is disposed between the first layer and the third layer, the third layer being constructed of a third material that is different than the first material and the second material.

5. The fuel cell stack of claim 4, wherein the third material is air, such that the third layer includes an air gap that is defined between the first layer and the second layer.

6. The fuel cell stack of claim 4, wherein the third material has a low bonding strength with the first material and the second material, the low bonding strength being sufficient for reducing chemistry and bonding interference between the first layer and the second layer.

7. The fuel cell stack of claim 1, wherein the bipolar plates each include a metal bead joint, and wherein the multi-layer seal includes a thin layer seal disposed on a surface of the metal bead joint.

8. The fuel cell stack of claim 7, wherein the first material of the multi-layer seal includes a foam fluorinated carbon-based synthetic rubber (FKM), and wherein the second layer is applied to the surface of the metal bead joint includes a solid FKM.

9. A fuel cell system (FCS), comprising:
a reactant supply tank containing a reactant gas;
a fuel cell stack in fluid communication with the reactant supply tank, and configured to receive a coolant and the reactant gas; and
a load configured to be driven by an electrical current from the fuel cell stack, wherein the fuel cell stack includes:
a pair of end plate units each having a metal plate, a dielectric plate, and a perimeter groove defined by the dielectric plate and the metal plate;
a gas inlet configured to receive a reactant gas into the fuel cell stack;
a coolant inlet configured to receive the coolant into the fuel cell stack;
a plurality of fuel cells, wherein each respective fuel cell of the plurality of fuel cells includes a pair of bipolar plates; and
a multi-layer seal disposed within the fuel cell stack, the multi-layer seal including:
a first layer constructed of a first material that is substantially impermeable to the reactant gas and the coolant; and
a second layer constructed of a second material that is more resistant to corrosion than the first material.

10. The FCS of claim 9, wherein the multi-layer seal is disposed between the metal plate and the dielectric plate of each of the end plate units.

11. The FCS of claim 10, wherein a bonding strength and a maximum tensile elongation of the second layer to the dielectric plate and the metal plate is higher than a bonding strength and a maximum tensile elongation of the first material to the dielectric and the metal plate.

12. The FCS of claim 9, wherein the multi-layer seal includes a third layer that is disposed between the first layer and the third layer, the third layer being constructed of a third material that is different than the first material and the second material.

13. The FCS of claim 12, wherein the third material is air, such that the third layer includes an air gap that is defined between the first layer and the second layer.

14. The FCS of claim 12, wherein the third material has a low bonding strength with the first material and the second material, the low bonding strength being sufficient for reducing chemistry and bonding interference between the first layer and the second layer.

15. The FCS of claim 9, wherein the bipolar plates each include a metal bead joint, and wherein the multi-layer seal is formed at least in part as a metal bead seal on a surface of the metal bead joint.

16. The FCS of claim 15, wherein the first material of the multi-layer seal includes a foam fluorinated carbon-based synthetic rubber (FKM), and wherein the second layer is applied to the surface of the metal bead joint and includes a solid FKM.

17. The FCS of claim 9, wherein the FCS is part of an electrified powertrain system having an electric traction motor as at least part of the load.

18. A method for sealing a fuel cell stack having a plurality of fuel cells disposed between end plate units, comprising:
applying a first material to an end plate unit of the fuel cells as a first layer, wherein the first layer that is substantially impermeable to a reactant gas and a coolant used in the fuel cell stack;
applying a second material to the end plate unit as a second layer, thereby forming a multi-layer seal, wherein the second material is more resistant to corrosion than the first material; and
curing the first layer and the second layer to thereby form the multi-layer seal.

19. The method claim 18, further comprising:
applying a third material as a third layer between the first layer and the second layer, wherein the third material is different than the first material and the second material and has a low bonding strength therewith, and wherein the low bonding strength is sufficient for reducing chemistry and bonding interference between the first layer and the second layer.

20. The method of claim 18, wherein applying the first material includes using a form-in-place gasket process, and wherein applying the second material includes using a manual dispensing process.
